(19) United States
(12) Patent Application Publication
(10) Pub. No.: US 2022/0284108 A1
(43) Pub. Date: Sep. 8, 2022

(54) SECURITY ASSESSMENT APPARATUS, SECURITY ASSESSMENT METHOD, AND NON-TRANSITORY COMPUTER READABLE MEDIUM

(71) Applicant: NEC Corporation, Minato-ku, Tokyo (JP)

(72) Inventors: Taniya SINGH, Tokyo (JP); Masafumi WATANABE, Tokyo (JP)

(73) Assignee: NEC Corporation, Minato-ku, Tokyo (JP)

(21) Appl. No.: 17/634,299

(22) PCT Filed: Aug. 23, 2019
(86) PCT No.: PCT/JP2019/032934

§ 371 Date: Feb. 10, 2022

(51) Int. Cl. G06F 21/57; G06F 21/54; G06F 21/55

(52) U.S. Cl. CPC G06F 21/577; G06F 21/54; G06F 21/554; G06F 2221/034

(57) ABSTRACT

The present disclosure provides a security assessment apparatus (8) of a facility to be controlled using a controller, the security assessment apparatus (8) including: a binary tree generating unit (5) configured to generate a binary tree from controller program code of the controller; a transition rules generating unit (6) configured to generate transition rules from the binary tree; and a controller rules generating unit configured to generate controller rules from the transition rules, the controller rules modeling the actual behavior of the controller.

### TECHNICAL FIELD

The present disclosure relates to a security assessment apparatus, a security assessment method, and a non-transitory computer readable medium.

### BACKGROUND ART

Patent Literature 1 discloses a control system for distributed sensors and actuators. The control system includes Programmable Logic Controllers (PLCs) for controlling the actuators.

### CITATION LIST

### Patent Literature

[Patent Literature 1] EP0550809A1

### SUMMARY OF INVENTION

### Technical Problem

Industrial Control Systems (ICS) include controllers such as PLCs. The PLCs are critical to the automated functioning of the Industrial Control Systems. The PLCs are Hardware devices which includes a Central Processing Unit (CPU), Memory, Input/output Module and so on. The input module is connected to the devices like sensors, switches etc. The output Module is connected to the actuators like Pump, Motor Valve.

Security Risk Assessment of the PLCs in an Industrial Control Systems can be done using a Model Checker. Creating the model checking rules manually for a large ICS with large number of PLCs is time consuming. Automatic generation of such model checking rules will reduce the effort and time to a great extent.

Automatic Assessment of an Industrial Control system requires the rules to be generated for the controller program as well as for the Physical devices controlled by the PLC. When dealing with critical infrastructures, the assessment should be fast. Due to the complexity of PLC programs, they take a large amount of time to execute and hence, generating rules directly from the PLC programs take a large amount of time. Consequently, the time required for the security risk assessment of an ICS will be more.

The problem of large execution time of PLC programs is due to the large number of variables present in the PLC program. The security risk assessment in the control system such as the PLC requires the control rules to be generated for the controller. The control rules generated by the method of execution of the PLC program takes a large amount of time to generate.

The large amount of time to generate the controller rules is due to the large execution time of the PLC program. The execution time of PLC programs is large due to the large number of variables present in a PLC programs.

The present disclosure has been made in view of the aforementioned problem and aims to provide a security assessment apparatus, a security assessment method, and a non-transitory computer readable medium capable of making an assessment of reducing the execution time of the controller programs.

### Solution to Problem

A security assessment apparatus according to the embodiment is a security assessment apparatus of a facility to be controlled using a controller, the security assessment apparatus including: a binary tree generating unit configured to generate a binary tree from controller program code of the controller; a transition rules generating function configured to generate transition rules from the binary tree; and a controller rules generating unit configured to generate controller rules from the transition rules, the controller rules modeling behavior of the controller.

A security assessment method according to the embodiment is a security assessment method of a facility to be controlled using a controller, the security assessment method including: generating a binary tree from controller program code of the controller; generating transition rules from the binary tree; and generating controller rules from the transition rules, the controller rules modeling behavior of the controller.

A non-transitory computer readable medium according to the embodiment is a non-transitory computer readable medium storing a program for causing a computer to execute a security assessment method of a facility to be controlled using a controller, the security assessment method comprising: generating a binary tree from controller program code of the controller; generating transition rules from the binary tree; and generating controller rules from the transition rules, the controller rules modeling behavior of the controller.

### Advantageous Effects of Invention

An objective of the present disclosure is to provide a security assessment apparatus, a security assessment method and a non-transitory computer readable medium capable of reducing the execution time of controller programs.

### BRIEF DESCRIPTION OF DRAWINGS

FIG. 1 is a block diagram illustrating a configuration of a security risk assessment apparatus;

FIG. 2 shows an example of the binary tree;

FIG. 3 shows an example code snippet of PLC program;

FIG. 4 is a table illustrating the type information;

FIG. 5 is a flow diagram illustrating the flow of the operation of the first example embodiment;

FIG. 6 is a block diagram illustrating the Transition rules generating function of the first example embodiment;

FIG. 7 is a diagram illustrating the difference between the conventional approach and the new proposed approach to generate transition rules; and

FIG. 8 is a flow diagram illustrating the flow of the operation of the sub-function of the first example embodiment.

### DESCRIPTION OF EMBODIMENTS

Specific embodiments are described hereinafter in detail with reference to the drawings. The same or corresponding elements are denoted by the same reference symbols throughout the drawings, and repetitive descriptions are avoided for clarity.

A security assessment apparatus according to this embodiment makes an assessment of the security risk of the controller such as a Programmable Logic Controller (PLC) in an Industrial Control System (ICS). A security assessment apparatus 8 according to this embodiment makes an assessment of the security level in an Industrial Control System (ICS). The security assessment apparatus 8 makes an assessment of, for example, the cyber security level of a control system that uses a Programmable Logic Controller (PLC) (e.g., a Supervisory Control And Data Acquisition (SCADA) system).

A facility to be controlled such as a plant, a factory, an infrastructure facility, or a building is monitored and controlled using a controller such as the PLC. The facility to be controlled includes a plurality of actuators and sensors. The sensors include, for example, a water level indicator, a flow indicator, a speed indicator, a manometer, a thermometer and sends the sensing results to the PLC. The actuators include for example, a Motor Valve, a pump operated by the commands from the controller. The PLC is a controller that controls the actuator in accordance with the output from the sensor. Specifically, the PLC controls the facility to be controlled by outputting commands to the actuator in accordance with a PLC program programmed in advance.

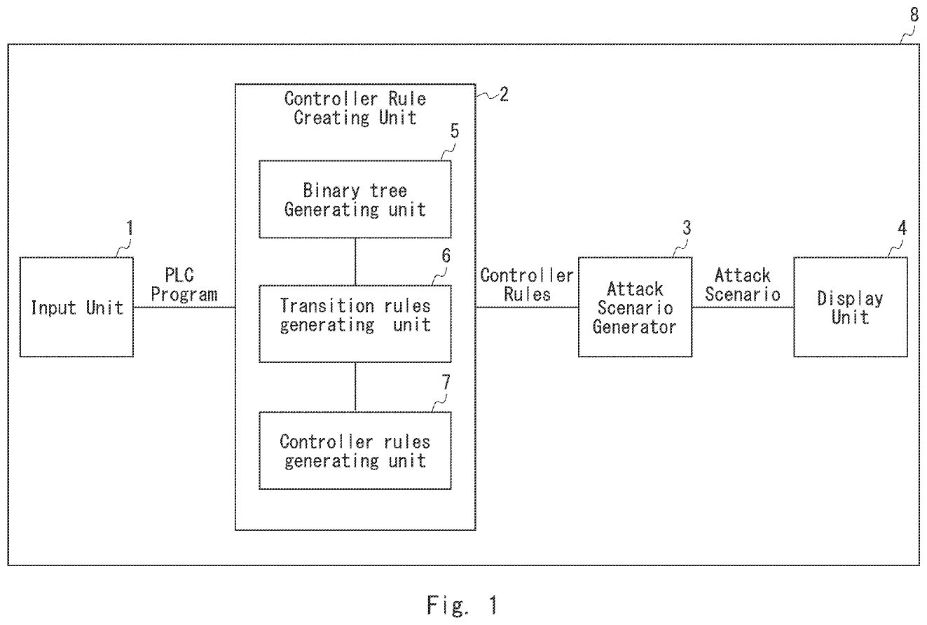

FIG. 1 describes a security assessment apparatus 1 that assesses the security of the controller such as the PLC against potential risks. The Security risk assessment is done by generating potential attack scenarios in the controller. The security assessment apparatus 8 includes an input unit 1, a controller rule creating unit 2, an attack scenario generator 3 and a display unit 4. The input unit 1 includes an input device or interface. The input unit 1 is used for inputting the PLC program and type information. For example, an user such as a plant operator inputs the type information and the PLC program by the input device. Or the PLC program and type information are automatically input to the security assessment apparatus 1 through the interface.

The controller rule creating unit 2 includes a binary tree generating unit 5, a transition rules generating unit 6 and a controller rules generating unit 7. The binary tree generating unit 5, the transition rules generating unit 6 and the controller rules generating unit 7 are provided in the controller rule creating unit 2. The binary tree generating unit 5, the transition rules generating unit 6 and the controller rules generating unit 7 are sub-functions of the controller rule creating unit 2.

The controller rule creating unit 2 receives the PLC program and type information from the input unit 1. The PLC program is a controller program code to control the actuators in the facility. The binary tree generating unit 5 generates a binary tree of the PLC program based on the PLC program and the type information. The binary tree generating unit 5 converts the PLC program into a binary tree structure using the type information.

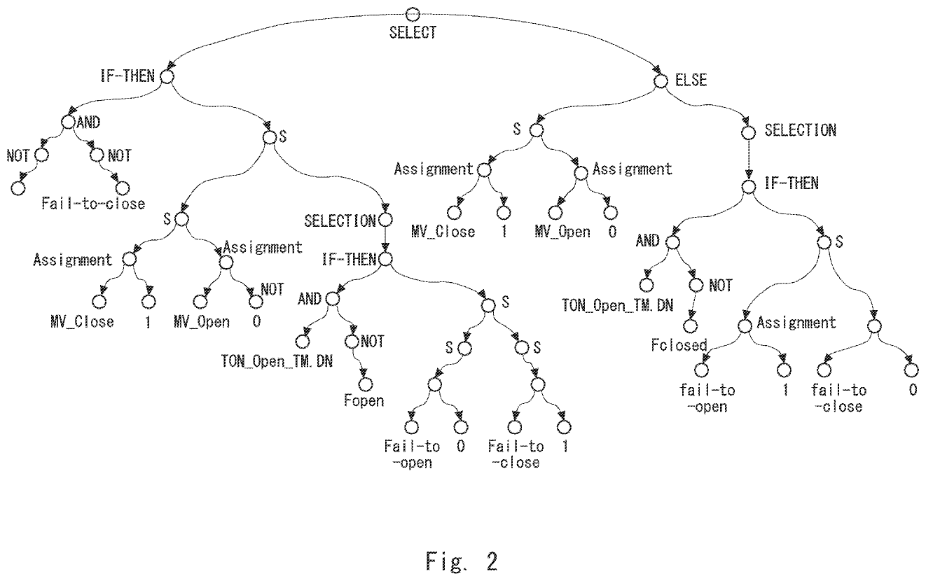

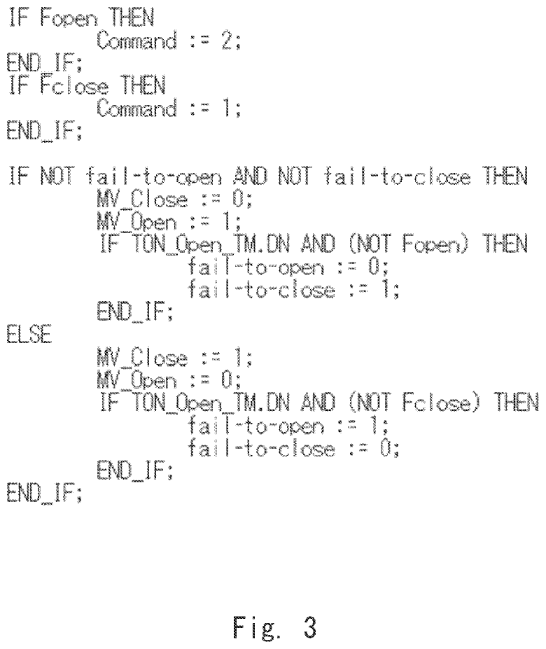

Each node in the binary tree represents either a keyword, an operator, a variable, a value or a SELECTION. The keywords are the pre-defined reserved words in the PLC program like IF-THEN, ELSE-IF-THEN, ELSE etc. A SELECTION node shows that exactly one out of IF-THEN-ELSE is selected. Therefore, a SELECTION node is always the immediate preceding node to the IF-THEN and ELSE node. FIG. 2 shows a sample Binary Tree constructed from a structured text code snippet of a PLC program shown in FIG. 3.

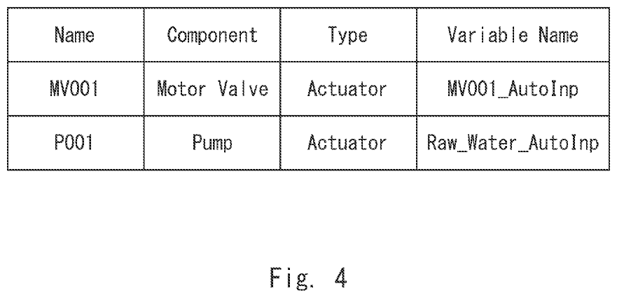

The type information specifies the type of the components such as the actuators present in the controller such as the PLC. FIG. 4 shows a table representing the type information of the controller named PLC001. The type information of the controller PLC001 shows the actuators controlled by the PLC001. The name column contains the names of the actuators defined in the controller PLC001. The component column contains the name of the component. The type column contains the type of the component. The type column defines the type of actuators. For example, the type column indicates “Motor valve” or “Pump”. The variables column contains the output variable name to the component. The PLC “PL001” outputs a value of the output variable to the actuator. In FIG. 4, there are only two components in the table, however a number of components listed in the table representing the type information is not limited to two. That is, the controller rules creating unit 2 may receive the type information of all components controlled by the controller “PLC001”.

The transition rules generating unit 6 takes the binary tree of the PLC program and the type information to generate intermediate transition rules. A transition rule is a mapping between the values of the input variables to the corresponding values of the output variables of the controller. The values of the output variables are usually (traditionally) obtained by executing the entire PLC program. The input variable of the controller is the variable that receives values from the component connected to the PLC. For example, the controller receives values from the sensor connected to it as the input variable that corresponds to the sensor. The output variable of the controller is the variable whose value is computed by the controller using the values of the input variables.

For example, by using the value of the input variable having the sensor value, the controller can compute the value of the output variable corresponding to the actuators indicating whether the actuators should be turned OFF/ON. The PLC controls the actuator by outputting the value of the output variables to the actuator.

These transition rules are then converted into controller rules by the controller rules generating unit 7. The controller rules generating unit 7 generates the controller rules based on the transition rules and the type information. The controller rules are model checking rules which models behavior of the controller. As described above, the controller rule creating unit 2 creates the controller rules of the controller from the PLC program of the PLC and the type information of the actuators.

The controller rules are then inserted into the attack scenario generator 3 to generate attack scenarios. The attack scenario generator 3 generates the attack scenarios using the controller rules. The attack scenario generator 3 generates the attack scenarios by executing the controller rules in case of a cyber-attack on the facility. The generated attack scenarios are displayed to the plant operator on the display unit 4. The security assessment apparatus 8 can assess security risk of the facility.

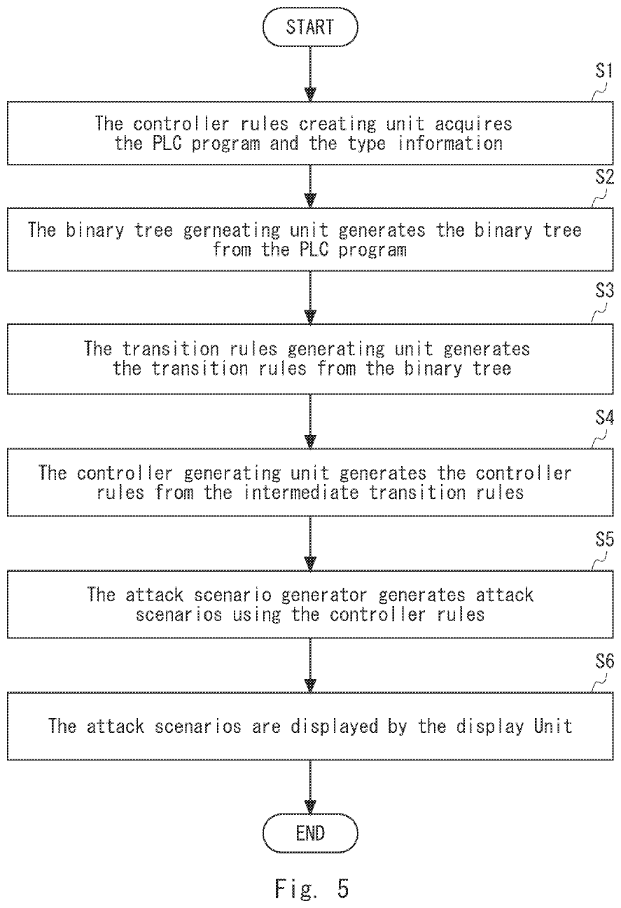

FIG. 5 is a flowchart showing a security assessment method in the security assessment apparatus 8. First, the controller rule creating unit 2 acquires the PLC program and the type information as the input from the input unit 1 (S1). The binary tree generating unit 5 generates the binary tree from the PLC program (S2). The binary tree generating unit 5 converts the PLC program into the binary tree by using the type information.

The controller rule creating unit 2 passes the binary tree of the PLC program and the type information to the transition rules generating function 6. The transition rules generating unit 6 generates the transition rules of the controller from the binary tree (S3). The transition rules generating function 6 converts the PLC program into a binary tree structure by using the type information.

The controller rules generating unit 7 generates the controller rules from the intermediate transition rules (S4). The controller rules generating function 7 converts the transition rules into the controller rules by using the type information.

The Attack scenario generator 3 generates attack scenarios using the controller rules (S5). The controller rules are taken as input by the attack scenario generator 3. The controller rules are executed using a model checker. The potential attack scenario generated by the attack scenario generator 3 is refined into a more readable form and passed to the display unit 4. The attack scenario generator 3 includes the model checker which assesses the security risk of the PLC. Finally, the attack scenarios are displayed by the display unit 4 (S6).

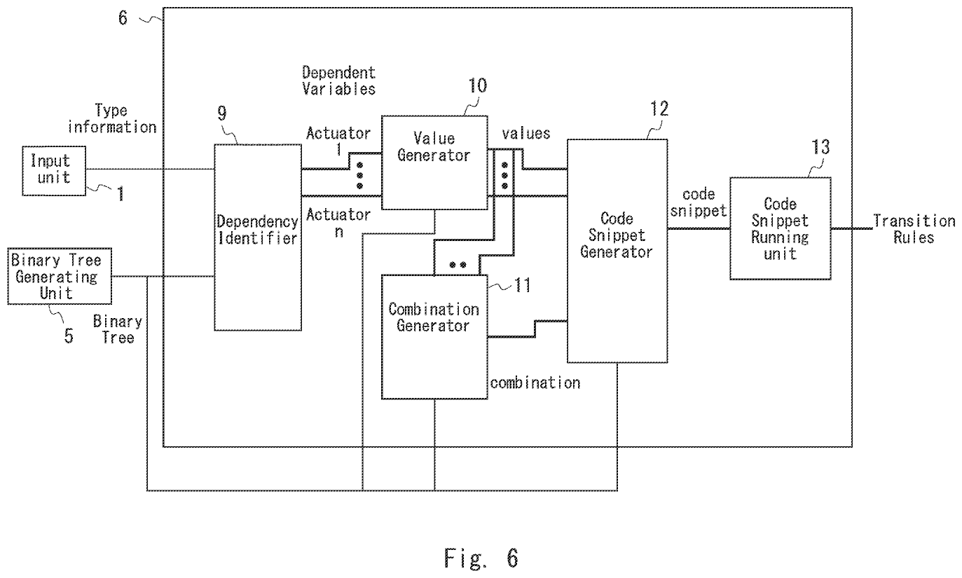

FIG. 6 describes a sub-function of the controller rule creating unit 2 namely the transition rules generating unit 6. The transition rules generating unit 6 generates the transition rules from the binary tree of the PLC Program in a fast and efficient manner. The transition rules generating unit 6 includes a dependency identifier 9, a value generator 10, a combination generator 11, a code snippet generator 12 and a code snippet running unit 13.

The transition rules generating unit 6 extracts code snippets for each actuator in the PLC and executes them separately to generate transition rules faster. The code snippets can be generated in any programming language such as python, Java or the like. The transition rules generated by this embodiment are exhaustive i.e. they model the actual behavior of the PLC completely and accurately, and also, the number of transition rules are reduced due to independent execution of actuator code snippets.

In FIG. 6, the transition rules generating unit 6 takes the binary tree of the PLC program and the type information as input. The dependent variables are defined for each type of actuator in the type information. The dependency identifier 9 takes the binary tree and the type information, and then generates the dependent variables for each actuator based on the binary tree and the type information. The dependent variables of an actuator are the input, output and internal variables associated with the actuator in the PLC program which governs the working of the actuator.

The dependent variables such as the input, output and internal variables are pre-defined for each type of the actuator. The PLC outputs a value of the output variable to the actuator to control the actuator. The component such as actuator or sensor outputs a value of the input variable to PLC, and thereby the PLC recognizes the current status of the component.

The internal variables are the variables present inside the PLC program. The internal variables are not directly associated to any physical component connected to the PLC but are used in the internal processing of the PLC program. For example, to check whether the water level in a tank is above HIGH limit or not, the input variable in the PLC associated with the tank WT_101_IN represents the current level of water in the water tank. The sensor such as a water level indicator detects the water level of water tank, and outputs detected water level as a value of the input variables to the PLC. This value is then copied to the internal variable WT_101_INTR. This internal variable is compared to the High set point, if WT_101_INTR>HIGH then the output variable corresponding to the HIGH ALARM is set to 1.

The value generator 10 receives the dependent variables of each actuator and the binary tree of the PLC program as input and generates all possible values for the dependent variables of each actuator by using the dependent variables of the respective actuators and the binary tree of the PLC program. The value generator 10 outputs the possible values to the combination generator 11 and the code snippet generator 12. The possible values of each dependent variable are already defined in the PLC program and the values of these dependent variables are determined explicitly from the PLC code. For example, Actuator “PMP101” has 3 dependent variables namely “PMP_101_IN”, “PMP_101_INTR”, “PMP_101_OP”. “PMP_101_IN” is the input variable which receives the current status of the pump (“RUNNING” or “STOPPED”) i.e. it has two possible values 0 when the pump is STOPPED and 1 when the pump is RUNNING. “PMP_101_INTR” is the internal variable that gets updated with the current level of water in the Tank (“Low Low”, “Low”, “Medium”, “High” “High High”) i.e. it has 5 possible values 0 for “Low Low”,1 for “Low”,2 for “Medium”,3 for “High”,4 for “High High”. “PMP_101_OP” is the output variable whose value is set to “Running” if the “PMP_101_INTR” value “High High” or “High”, it is set to “Stopped” if the “PMP_101_INTR” value is “Low” or “Low Low” i.e. it has 2 possible values 0 for “STOPPED” and 1 for “RUNNING”.

The combination generator 11 receives the binary tree of the PLC program, the possible values of the dependent variables of each actuator and generates all possible combinations of values of dependent variables for actuators in the PLC. The combination of one actuator may include all possible values of all dependent variables in the actuator.

For Example, referring to the Actuator “PMP101” there are 3 dependent variables “PMP_101_IN”, “PMP_101_INTR”, “PMP_101_OP” each having 2, 5, 2 values respectively. Therefore, there are 20 (=2×5×2) combinations of variables for actuator PMP101 as follows: (0,0,0), (0,1,0), (0,2,0), (0,3,0), (0,4,0), (0,0,1), (0,1,1), (0,2,1), (0,3,1), (0,4,1), (1,0,0), (1,1,0), (1,2,0), (1,3,0), (1,4,0), (1,0,1), (1,1,1), (1,2,1), (1,3,1), (1,4,1). “PMP_101_IN” is an input variable. “PMP_101 INTR”, is an internal variable. “PMP_101 OP” is an output variable.

Hence, if there are n (n is an integer larger than 1) dependent variables in an actuator and x (x is an integer larger than 0) variables have i (i is an integer larger than 0) number of possible values, y (x is an integer larger than 0) variables have j (j is an integer larger than 0) number of possible values such that n=x+y, then C=xⁱ×yⁱ where C is the number of combinations of the values of the dependent variables in an actuator. The combination generator 11 generates combinations for all actuators in the PLC. The combination generator 11 outputs the possible combinations to the code snippet generator 12.

The code snippet generator 12 receives the possible values of the dependent variables of each actuator, all possible combination of values of dependent variables for each actuator and the binary tree as input. The code snippet generator 12 generates code snippets for each actuator using these inputs. The code snippet generator 12 can extract the code of various actuators from the PLC program. Exactly one code snippet will be generated for each actuator. That is, when there are l (l is an integer larger than 1) actuators in the PLC, the code snippet generator 12 generates l code snippets. The code snippet generator can divide the PLC program into small code snippets. As described above, the code snippets are divided for each actuator. Or the one code snippet will be generated for two or more actuators.

The code snippet running unit 13 executes the code snippets of each actuator independently and generates transition rules for each actuator separately. Since the code snippet is generated for each actuator, the code snippet running unit 13 separately generates the transition rules of each actuator. That is, the transition rules are divided for each actuator. The code snippet running unit 13 executes the code snippet by sequentially inputting all the values of the dependent variables to the code snippet. By changing the values of the dependent variables exhaustively, the code snippet unit generates the transition rules of the actuators.

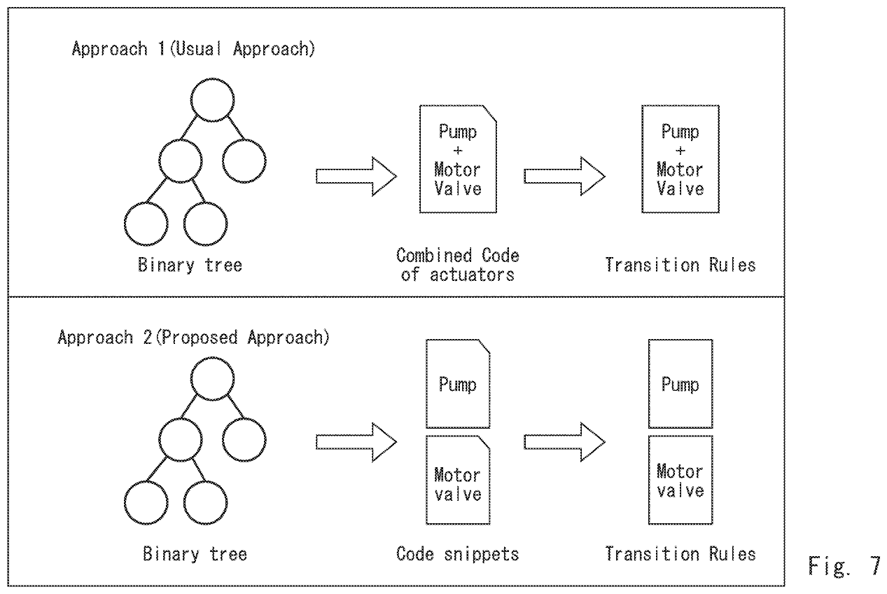

FIG. 7 shows an experimentation to show the method of this new transition rules generating unit 6 as compared to usual approach (i.e. approach 1). In the experimentation, the binary tree of the PLC program is generated from the PLC code using Python language. In the usual approach, we extracted a combined code of actuators (i.e. Pump and Motor valve) from the binary tree of a PLC program. That is, Pump and Motor Valve code is extracted together as a single program file and this file is executed to generate the transition rules. The transition rules include rules regarding Pump and Motor Valve. In our proposed approach (i.e. approach 2), the code snippet for each actuator is extracted as separate files and each file is executed separately. The transition rules generating unit 6 separately generates the transition rules of the Pump and the transition rules of Motor valve. In the proposed approach, the number of dependent variables included in one code snippet can be small. Therefore, the total number of transition rules of the proposed approach can be smaller than that of the usual approach.

The two methods were applied to a sample PLC program. In the usual approach, the total number of transition rules generated by executing the combined code of the actuators were 786432 whereas in our proposed approach, the number of transition rules generated by executing the code snippet of the Pump is 24576 and the number of transition rules generated by executing the code snippet of Motor valve is 12288. Hence, the total number of transition rules are 24576+12288=36864. The total number of reduction in the transition rules by our approach is 786432-36864=749568. There is a 95.31% ((749568/786432)*100) decrease in the number of transition rules. In the usual approach, the combined code of the actuators has a large number of redundant dependent variables that results in a large number of transition rules. For example, if in the combined code m dependent variables belong to actuator A1 and n dependent variables belong to actuator A2 and each of these dependent variables have 2 possible values. Then, there are 2^{(m+n)} transition rules whereas in our approach, the actuators are extracted separately and hence there are 2^{m}+2ⁿ transition rules. Hence, eliminating the redundant dependent variables will reduce the number of transition rules.

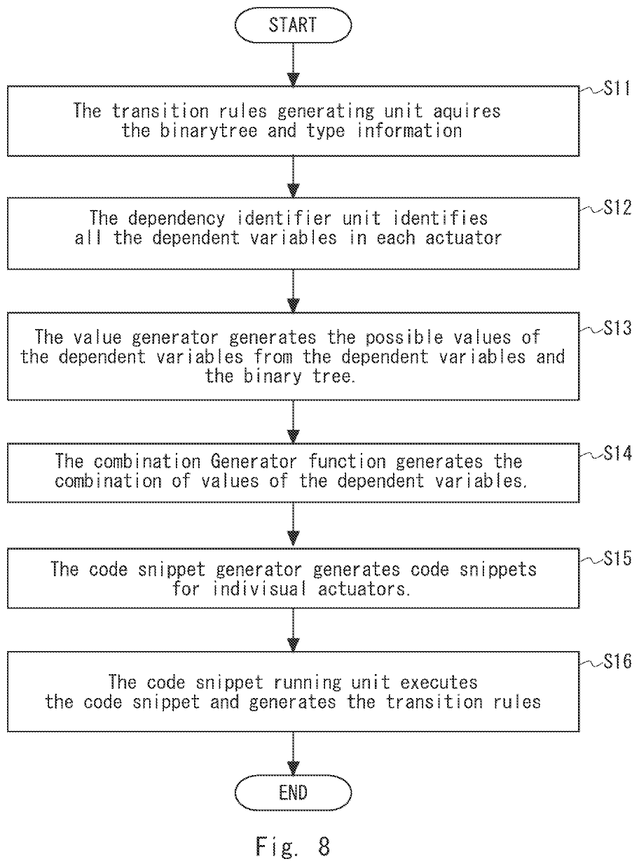

FIG. 8 is a flowchart showing a transition rule generation method of the transition rules generating function 6. First, the transition rules generating unit 6. acquires the binary tree and the type information (S11). The binary tree generating unit 5 passes the binary tree to the dependency identifier 9, the value generator 10, the combination generator 11 and the code snippet generator 12.

The dependency identifier 9 identifies the dependent variables in each actuator (S12). The dependency identifier 9 extracts all the dependent variables from the binary tree using the type information. The dependency identifier 9 outputs the dependent variables to the value generators 10.

The value generator 10 generates possible values of the dependent variables from the dependent variables and the binary tree (S13). The value generator 10 outputs all the possible values to the combination generator 11 and the code snippet generator 12.

The combination generator 11 generates the combination of values of the dependent variables (S14). The combination generator 11 outputs all the combination to the code snippet generator 12

The code snippet generator 12 takes the binary tree, the possible values of dependent variables of each actuator and the combination of values of the dependent variables of each actuator. The code snippet generator 12 generates code snippets for individual actuators using these inputs (S15). Finally, the code snippet running unit 13 executes the code snippet and generates the transition rules (S16). The code snippet running unit 13 executes the code snippet which are divided into each actuator. The code snippet running unit 13 executes each of the code snippets by using all the possible combinations of the dependent variables. By using the all the possible values and all the possible combination, the transition rules are separately generated for each actuator.

Therefore, it is possible for the security assessment apparatus 8 to reduce the execution time of the controller program. Further, it is possible to assess the security risk accurately. Therefore, it is possible to make an assessment of a security level simply and appropriately.

In the aforementioned embodiments, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described above with reference to the embodiments, the present disclosure is not limited to the aforementioned description. Various changes that may be understood by one skilled in the art may be made on the configuration and the details of the present disclosure within the scope of the present disclosure.

### REFERENCE SIGNS LIST

1 INPUT UNIT
2 CONTROLLER RULE CREATING UNIT
3 ATTACK SCENARIO GENERATOR
4 DISPLAY UNIT
5 BINARY TREE GENERATING UNIT
6 TRANSITION RULES GENERATING UNIT
7 CONTROLLER RULES CREATING UNIT
8 SECURITY ASSESSMENT APPARATUS
9 DEPENDENCY IDENTIFIER
10 VALUE GENERATOR
11 COMBINATION GENERATOR
12 CODE SNIPPET GENERATOR
13 CODE SNIPPET RUNNING UNIT

What is claimed is:

1. A security assessment apparatus of a facility to be controlled using a controller, the security assessment apparatus comprising:
a binary tree generating unit configured to generate a binary tree from controller program code of the controller;
a transition rules generating unit configured to generate transition rules from the binary tree; and
a controller rules generating unit configured to generate controller rules from the transition rules, the controller rules modeling behavior of the controller.

2. The security assessment apparatus according to claim 1, wherein:
the binary tree generating unit receives the controller program code and the type information of actuator, and converts the controller program code into a binary tree structure using the type information;
the transition rules generating unit receives the binary tree and the type information to generate the transition rules; and
the controller rules generating unit converts the transition rules into the controller rules using the type information.

3. The security assessment apparatus according to claim 1, wherein the transition rules generating unit comprising:
a dependency identifier configured to generate dependent variables for plurality of actuators in the controller;
a value generator configured to generate possible values of the dependent variables;
a combination generator configured to generate possible combination of values of the dependent variables;
a code snippet generator configured generate the code snippets for the plurality of the actuators using the possible values and the possible combinations; and
a code snippet running unit configured to run the code snippet to generate the transition rules.

4. The security assessment apparatus according to claim 3, wherein:
the dependency identifier receives the binary tree and the type information and generates dependent variables for each of the actuators in the controller.
the value generator receives the binary tree and the dependent variables and generates all the possible values for each of the dependent variables;
the value generator receives the binary tree and all the possible values of the dependent variables and generates all the possible combination of values of the dependent variables in each of the actuators of the controller.
the code snippet generator receives all the possible values, all the possible combination and binary tree to extract the code snippet of each actuator separately from the controller program code.
the code snippet running function receives all the possible values and all the possible combination to separately generate the transition rules for each actuator.

5. The security assessment apparatus for a controller according to claim 1, further
comprising an attack scenario generator configured to generate potential attack scenarios in the controller using the controller rules.

6. A security assessment method of a facility to be controlled using a controller, the security assessment method comprising:
generating a binary tree from controller program code of the controller;
generating transition rules from the binary tree; and
generating controller rules from the transition rules, the controller rules modeling behavior of the controller.

7. The security assessment method according to claim 6, wherein:
the binary tree is generated by converting the controller program code into the binary tree with using type information of the actuator;
the transition rules are generated by converting the binary tree into the transition rules with using the type information; and
the controller rules are generated by converting the transition rules into the controller rules with using the type information.

8. The security assessment method according to claim 6, wherein;
dependent variables for plurality of actuators are generated;
possible values for each of the dependent variables are generated;
possible combinations of values of the dependent variables are generated;
the code snippets for the plurality of the actuators are generated by extracting the code of the actuator from the controller program code; and
the transition rules are generated by running the code snippets.

9. The security assessment method according to claim 8, wherein:
by using the binary tree and the type information, the dependent variables for each of the actuators in the controller are generated;
by using the binary tree and the dependent variables, all the possible values for each of the dependent variables are generated;
by using the binary tree and the all the possible values all the possible combinations of the values of the dependent variables in each of the actuators of the controller are generated;
by using the all the possible values, all the possible combination and binary tree, the code snippets are separately generated for each of the actuators; and
by using the all the possible values and all the possible combination, the transition rules are separately generated for each of the actuators.

10. The security assessment method according to claim 6, further comprising generating potential attack scenarios in the controller using the controller rules.

11. A non-transitory computer readable medium storing a program for causing a computer to execute a security assessment method of a facility to be controlled using a controller, the security assessment method comprising:
generating a binary tree from controller program code of the controller;
generating transition rules from the binary tree; and
generating controller rules from the transition rules, the controller rules modeling behavior of the controller.

12. The non-transitory computer readable medium according to claim 11, wherein:
the binary tree is generated by converting the controller program code into the binary tree with using type information of the actuator;
the transition rules are generated by converting the binary tree into transition rules with using the type information; and
the controller rules are generated by converting the transition rules into the controller rules with using the type information.

13. The non-transitory computer readable medium according to claim 11, wherein,
dependent variables for plurality of actuators are generated;
possible values for each of the dependent variables are generated;
possible combinations of values of the dependent variables are generated;
the code snippets for the plurality of the actuators are generated by extracting the code of the actuator from the controller program code; and
the transition rules are generated by running the code snippets.

14. The non-transitory computer readable medium according to claim 13, wherein,
by using the binary tree and the type information, the dependent variables for each of the actuators in the controller are generated;
by using the binary tree and the dependent variables, all the possible values for each of the dependent variables are generated;
by using the binary tree and the all the possible values all the possible combinations of the values of the dependent variables in each of the actuators of the controller are generated;
by using the all the possible values and all the possible combination and binary tree, the code snippets are separately generated for each of the actuators; and
by using the all the possible values and all the possible combination, the transition rules are separately generated for each of the actuators.

15. The non-transitory computer readable medium according to claim 11, further comprising generating potential attack scenarios in the controller using the controller rules.
